(19) United States
(12) Patent Application Publication
(10) Pub. No.: US 2002/0091643 A1
(43) Pub. Date: Jul. 11, 2002

(54) Digital data distribution system

(76) Inventors: Ryuichi Okamoto, Studio City, CA (US); Masayuki Kozuka, Arcadia, CA (US); Mitsuhiro Inoue, Studio City, CA (US); Masataka Minami, Burbank, CA (US)

Correspondence Address: WENDEROTH, LIND & PONACK, L.L.P., 2033 K STREET N. W., SUITE 800, WASHINGTON, DC, 20006-1021, US

(21) Appl. No.: 09/757,577

(22) Filed: Jan. 11, 2001

(51) Int. Cl. G06F 17/60

(52) U.S. Cl. 705/53

(57) ABSTRACT

An object of the invention is to provide a digital data distribution system in which profits can be properly allocated to digital data provider companies and right holders of digital data, where the digital data distribution system offers subscription services.

The profit sharing means 314 refers to the profit sharing database 313, and allocates profits.

### BACKGROUND OF THE INVENTION

1) Field of the Invention

The present invention relates to a digital data distribution system that enables the Electronic Commerce, in which digital data is sold for a fee via a network.

2) Description of the Related Art

In the Electronic Commerce that is conducted via a network, a consumer generally accesses a homepage set up by an information provider. Then, the consumer selects digital data of his choice, goes through a purchasing process, and downloads the digital data. The digital data that has been downloaded undergoes a process for copyright protection such as encryption, in order to prevent illegal secondary distribution of the digital data that occurs through the network.

A conventional digital data distribution system will now be explained referring to FIG. 1.

Digital data to be distributed is stored in an encrypted state in digital data storage means 105, which is stored in a distribution server 101 operated by the information provider. Its decryption key, the storage location of the encrypted digital data itself, and use condition information of the digital data are stored in a digital data administration database 104. The use condition information herein refers to, for instance, information indicating that the digital data can be copied to another storage media up to three times after it is downloaded.

The consumer operates a receiving device 102, and accesses the distribution server 101 via sending and receiving means 108 and communication means 109.

A distribution front end 106 sends to the receiving device 102 a list of music digital data to be distributed. The list of the music digital data is created based on data in the digital data administration database 104. The consumer browses the list information using browsing means 110. When the consumer finds digital data he wishes distributed to him, he sends a request for purchasing the digital data and his user name to the distribution server 101. If the distribution front end 106 does not find the user name that has been sent in a user administration database 103, the distribution front end 106 sends to the browsing means 110 a request for payment information inputs such as credit card number. The consumer inputs the requested payment information via the browsing means 110, and sends the payment information to the distribution server 101. The distribution front end 106 records the payment information in the user administration database 103, and executes the payment process. If the user name is found in the user administration database 103, the payment process is executed using the payment information stored in the user administration database 103. Once the payment process is completed successfully, the distribution front end 106 directs the digital data distribution means 107 to send the digital data, of which the user requested distribution, to the receiving device 102. The digital data distribution means 107 retrieves the designated digital data from the distribution digital data storage means 105, and the decryption key and use condition information for the digital data from the digital data administration database 104, and sends them to the receiving device 102. Digital data administration means 111 stores the digital data it received in digital data storage means 113. The digital data administration means 111 also stores the decryption key and the use condition information it received in secure information storage means 112. The secure information storage means 112 stores these data after encrypting them with information that relates to the receiving device 102.

When the user plays the digital data on the receiving device 102, the digital data administration means 111 reads the encrypted digital data from the storage media 113, and its decryption key from the secure information storage means 112, and decrypts the digital data.

When the digital data written in the storage media 114 is to be copied to another portable storage media 117, the digital data administration means 111 first refers to the use condition information and copy history information that are stored in the secure information storage means 112. The copy history information indicates the number of times the digital data has been copied in the past. In this manner, the digital data administration means 111 determines whether the digital data may be copied. If the digital data administration means 111 determines that the digital data may be copied, media access process control means 114 receives the digital data and its decryption key from the digital data administration means 111, and copies them in the storage media 117 via storage media access means 116. At this time, the decryption key is copied after being encrypted with a media ID 118, which is an ID unique to each storage media 117 and has been detected by the media ID detection means 115. Once the digital data is copied to the storage media 117, the digital data administration means 111 increments the copy history information by one. The copy history information is stored in the secure information storage means 112.

As described above, in the conventional technology, the distribution server uses only the user information in order to conduct digital data distribution control. On the other hand, the receiving device administers the decryption key of the digital data, the use right information of the digital data, and the use history information of the digital data with designated secure information storage means 112, which cannot be accessed with a consumer's regular operation.

Such conventional digital data distribution system is always subject to possibilities of hacking activities by malicious consumers, such as illegal obtainment of the digital data from the distribution server 101 and illegal secondary distribution of the digital data that has been distributed to the receiving device 102. As a result, a portion that conducts administration of rights of digital data (the digital data administration means 111 and the secure information storage means 112) and the interface portion to the storage media (the media access process control means 114 and the media ID detecting means 115), which copies digital data to a storage media in a safe manner are more or less equipped with a tamper-resistant technology.

However, the aforesaid conventional structure has following problems, due to the fact that administration of rights of digital data is conducted within a receiving device. The module for administration of rights of digital data is not easy to use for a user. More specifically, such module requires complicated operations by the user. Also, the process of such module is slow because of the tamper resistant technology.

### SUMMARY OF THE INVENTION

The present invention has been conceived in view of the aforementioned situations. More specifically, the object of the present invention is to provide a digital data distribution system in which the distribution server conducts administration of rights of digital data.

In this system, it is possible to offer services that are more freely adjustable than those offered by conventional digital data distribution systems. For instance, the system of the present invention can offer a subscription service in which a user can freely download any desired digital data from a designated group of digital data up to a predetermined number of data, upon paying a fixed monthly fee. Another object of the present invention is to provide a system in which profits can be properly shared by right holders of digital data that are distributed by such subscription service.

To achieve the aforementioned object, the digital data distribution server of the present invention includes a history database storing information regarding digital data that have been distributed to users in the past, a profit sharing database storing information regarding amounts to be allocated in order to allocate fees collected from the users to right holders of the digital data that are distributed by the distribution server, and profit sharing means for calculating the amounts to be allocated to the right holders based on the information in the history database and the profit sharing database, and conducting a closing process.

The digital data distribution system of the present invention includes a distribution server that distributes digital data, a receiving device that receives the digital data sent from the distribution server, a storage media in which the digital data that the receiving device has received is written, and an adapter that writes in the storage media the digital data that the receiving device has received. The receiving device includes communication means for accessing the distribution server, browsing means for browsing and responding to information sent from the distribution server, and adapter connection control means for controlling connection with the adapter. The storage media includes a media ID, which is information specific to the storage media and cannot be tampered with, the media ID being able to uniquely identify the storage media. The adapter includes secure communication means, an adapter ID that uniquely identifies the adapter, adapter ID detecting means for extracting the adapter ID and sending the adapter ID to the distribution server, media ID detecting means for extracting the media ID from the storage media and sending the media ID to the distribution server, encryption conversion means, key encryption means, storage media access means for writing and reading data in and from the storage media, and media access process control means for controlling the writing and reading in and from the storage media by the storage media access means. The distribution server includes secure communication means, sending and receiving means for sending and receiving information and the digital data to and from the receiving device, a distribution front end for creating information to be sent to the user and processing accesses by the user, a user administration database that stores user IDs and account information of related users, a digital data administration database that stores storage location information and use conditions of digital data to be distributed, an obtained rights administration database that stores information regarding a right to receive distribution of digital data that each user has obtained, a history database that stores information regarding digital data that has been distributed to the users in the past, an adapter administration database that stores adapter IDs of adapters that each user uses, a storage media administration database that stores media IDs of storage medias that each user uses, a profit sharing database that stores information regarding amounts to be allocated when fees collected from the users are allocated to right holders of the digital data that are distributed by the distribution server, profit sharing means for calculating the amounts to be allocated to each of the right holders based on the information in the history database and the profit sharing database and conducting a closing process based on the calculation, distribution digital data storage means for storing digital data that are encrypted with a first encryption system and decryption keys for decrypting the digital data encrypted with the first encryption system, and digital data distribution means for sending to the receiving device the digital data encrypted with the first encryption system and the decryption key based on a direction from the distribution front end, the digital data and the decryption key being stored in the distribution digital data storage means. The encryption conversion means decrypts the digital data that is encrypted with the first encryption system and distributed by the digital data distribution means, using the decryption key distributed by the digital data distribution means, and encrypts the decrypted digital data with a second encryption system. The key encryption means encrypts the key that has been utilized when the encryption conversion means encrypted the digital data with the second encryption system, using the media ID detected by the media ID detecting means. The storage media access control means controls the storage media access means and writes the key encrypted by the key encryption means in the storage media. The secure communication means of the adapter and the secure communication means of the distribution server communicate with each other, thereby establishing a secure communication path between the adapter and the distribution server. The communication between each structural element within the adapter and each structural element within the distribution server is conducted through the secure communication path that has been established. The distribution front end authorizes a user based on the adapter ID sent from the adapter ID detecting means. The distribution front end determines whether the digital data with respect to which distribution is requested can be distributed, by referring to the obtained rights administration database, the history database, the digital data administration database, and the storage media administration database, in order to execute processes in response to a request for distribution of digital data from the authorized user.

The profit sharing method of sharing profit of the present invention is a method of sharing profits earned from a digital data distribution system. In the digital data distribution system, the profit sharing means refers to the history database and the profit sharing database, based on the information the profit sharing means calculating the amount to be allocated to each right holder and conducting a closing process based on the calculated amount.

### BRIEF DESCRIPTION OF THE DRAWINGS

FIG. 1 shows an example of a structure of a digital data distribution system in accordance with the conventional technology.

FIG. 2 shows an example of application of a digital data distribution system in accordance with the embodiment of the present invention.

FIG. 3 shows a structure of the digital data distribution system in accordance with the embodiment of the present invention.

FIG. 4 shows a structure of a storage media in accordance with the embodiment of the present invention.

FIG. 5 shows an example of a user account information database in accordance with the embodiment of the present invention.

FIG. 6 shows an example of an adapter information database in accordance with the embodiment of the present invention.

FIG. 7 shows an example of a storage media information database in accordance with the embodiment of the present invention.

FIG. 8 shows an example of a service type database in accordance with the embodiment of the present invention.

FIG. 9 shows an example of a digital data information database in accordance with the embodiment of the present invention.

FIG. 10 shows an example of an obtained rights administration database in accordance with the embodiment of the present invention.

FIG. 11 shows an example of a history database in accordance with the embodiment of the present invention.

FIG. 12 shows an example of a profit sharing database for a single sale service in accordance with the embodiments of the present invention.

FIG. 13 shows an example of a profit sharing database for a subscription service in accordance with the embodiment of the present invention.

FIG. 14 shows an example of profit sharing information in accordance with the embodiment of the present invention.

FIG. 15 is a flowchart of an overall operation of the digital data distribution system in accordance with the embodiment of the present invention.

FIG. 16 is a flowchart explaining a joining process in accordance with the embodiment of the present invention.

FIG. 17 is a flowchart explaining a digital data selection process in accordance with the embodiment of the present invention.

FIG. 18 is a flowchart explaining a subscription handling process in accordance with the embodiment of the present invention.

FIG. 19 is a flowchart explaining a single sale handling process in accordance with the embodiment of the present invention.

FIG. 20 is a flowchart explaining a digital data download process in accordance with the embodiment of the present invention.

FIG. 21 is a flowchart explaining a storage media legitimacy check process in accordance with the embodiment of the present invention.

FIG. 22 is a flowchart explaining a storage media writing process in accordance with the embodiment of the present invention.

FIG. 23 is a view of an example of a log-in screen that the receiving device in accordance with the embodiment of the present invention displays to the user.

FIG. 24 is a view of an example of a user registration screen that the receiving device in accordance with the embodiment of the present invention displays to the user.

FIG. 25 is a view of an example of a subscription service digital data selection screen that the receiving device in accordance with the embodiment of the present invention displays to the user.

FIG. 26 is a view of an example of a single sale service digital data selection screen that the receiving device in accordance with the embodiment of the present invention displays to the user.

FIG. 27 is a view of an example of a download digital data selection screen that the receiving device in accordance with the embodiment of the present invention displays to the user.

FIG. 28 is a flowchart explaining a profit sharing process in accordance with the embodiment of the present invention.

FIG. 29 shows an example of a structure of the digital data distribution system in accordance with the present invention.

FIG. 30 shows an example of a structure of the digital data distribution system in accordance with the present invention.

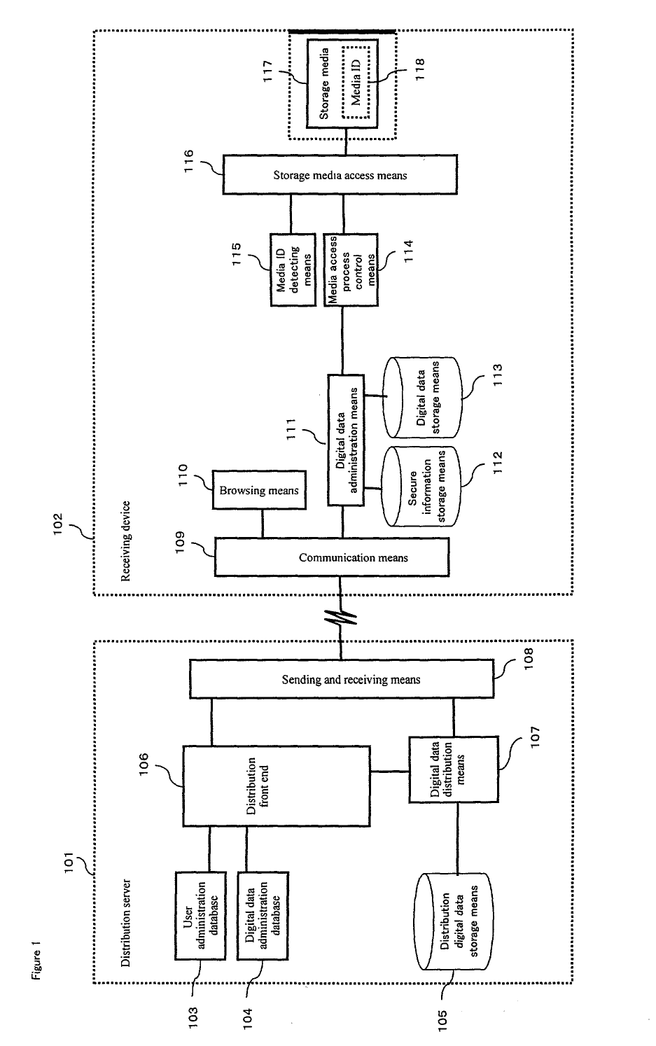

### DESCRIPTION OF THE PREFERRED EMBODIMENTS

An embodiment of the present invention will now be explained referring to figures.

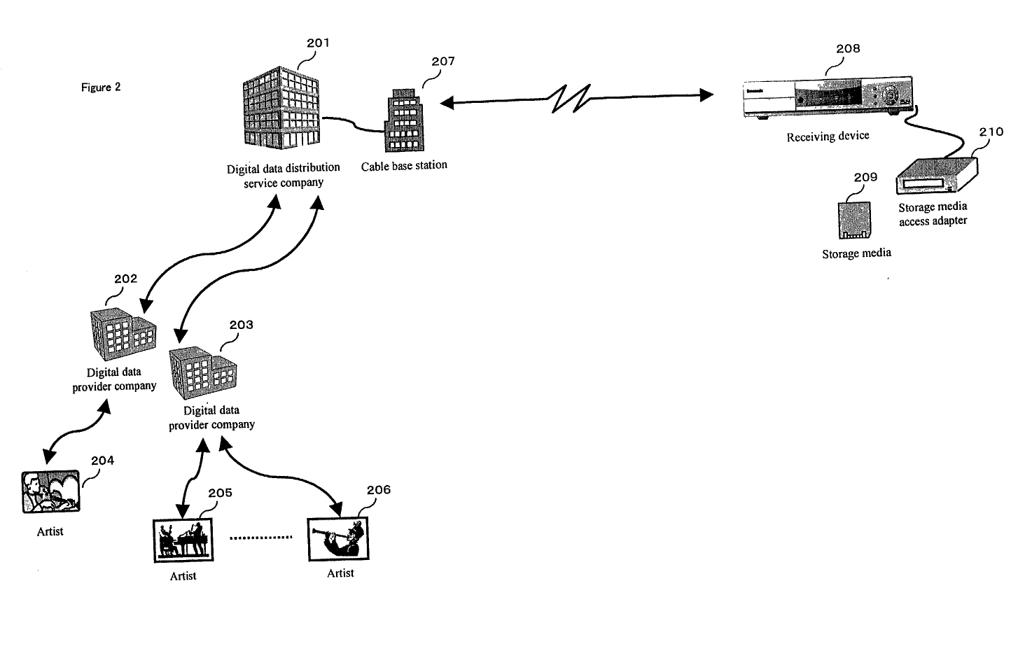

FIG. 2 is a view of an example of application of a digital data distribution system in accordance with the embodiment of the present invention. In FIG. 2, 201 is a digital data distribution service company which operates a distribution server for distributing digital data. 202 and 203 are digital data provider companies which provide digital data to digital data distribution service company. 204-206 are artists who hold rights to digital data. Each artist has a contract with a digital data provider company. 208 is a STB (Set Top Box), which is a receiving device operated by a consumer. 207 is a Cable base station, which connects the digital data distribution service company 201 and the receiving device 208 of the consumer via a Cable network. 209 is a storage media in which the distributed digital data is written. 210 is an access adapter that is connected to the receiving device 208, and writes in the storage media 209 the digital data that the receiving device 208 has received.

In this embodiment, a situation where the digital data is music digital data is discussed as an example. Also, services provided by the digital data distribution system include three services as examples: single sale service in which each song has a fixed price, a subscription service in which the consumer can freely download any desired songs from a designated group of music digital data up to a predetermined number upon paying a fixed monthly fee, and another subscription service in which the consumer can download any desired songs unlimitedly from a group of music digital data upon paying a fixed monthly fee.

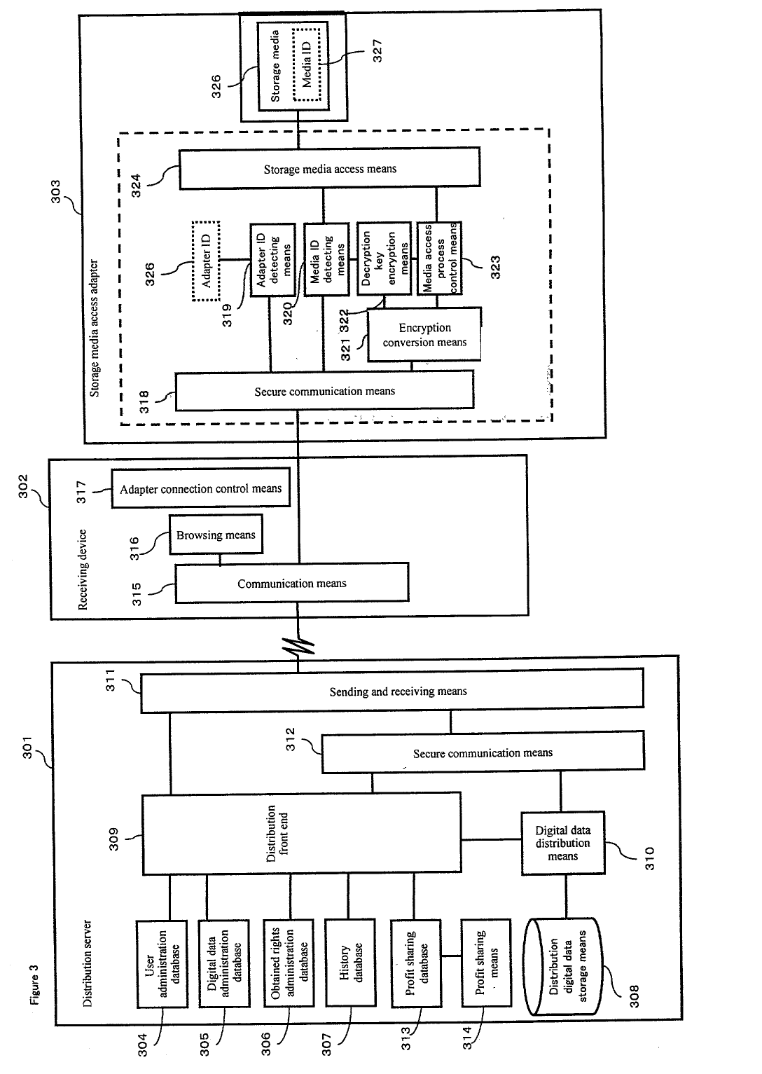

FIG. 3 is a view of a structure of a digital data distribution system in accordance with the present embodiment. The digital data distribution system of the present embodiment includes a distribution server 301, a receiving device 302, and a storage media access adapter 303.

The distribution server 301 is a server for distributing digital data. The distribution server 301 includes a user administration database 304, a digital data administration database 305, an obtained rights administration database 306, a history database 307, distributed digital data storage means 308, a distribution front end 309, digital data distribution means 310, sending and receiving means 311, secure communication means 312, a profit sharing database 313, and profit sharing means 314.

The receiving device 302 is a device that receives digital data. The receiving device 302 includes communication means 315, browsing means 316, and adapter connection control means 317.

The storage media access adapter 303 is an adapter that reads and writes data from and in a storage media 326. The storage media access adapter 303 has an adapter ID 325 which is an inherent ID that uniquely identifies the adapter. The storage media access adapter 303 includes secure communication means 318, adapter ID detecting means 319, media ID detecting means 320, encryption conversion means 321, decryption key encryption means 322, media access process control means 323, and storage media access means 324. In this embodiment, each of the structural elements in the storage media access adapter 303 is integrally installed within one LSI (a portion encircled by a broken line in FIG. 3).

Each structural element will now be explained below.

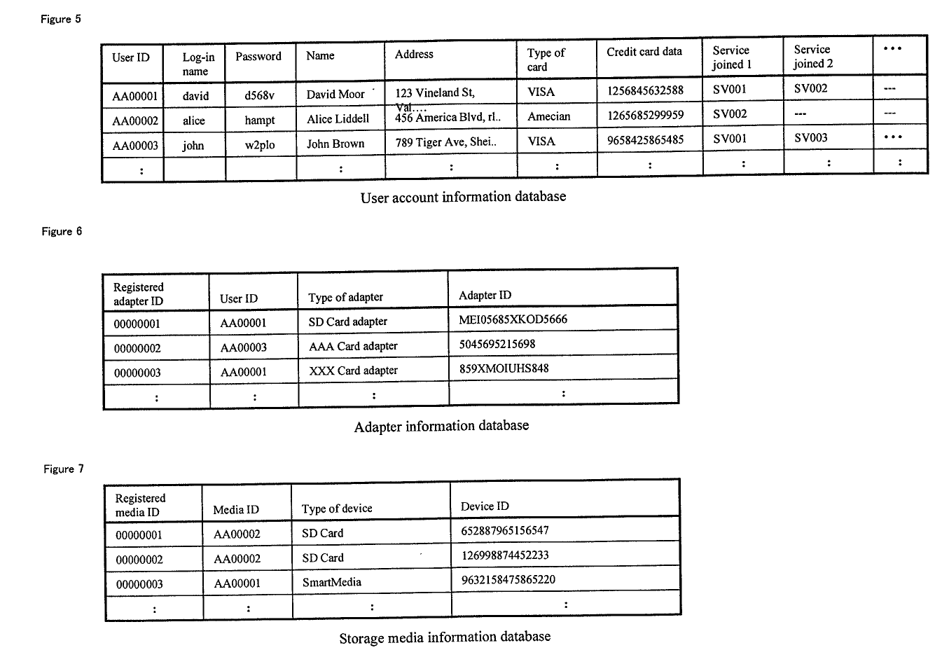

The user administration database 304 is a relational database that includes three databases: a user account information database that stores users' account information, an adapter information database that stores information regarding adapters that users own, and a storage media information database that stores information regarding storage medias that users have used as the distribution location in the past. FIG. 5 is a view of an example of the user account information database. The user account information database includes user ID, log-in name, password, user's name, user's address, the type of credit card with which payment is to be made, credit card number, and information regarding the music distribution service plans the user has joined. FIG. 6 is a view of an example of the adapter information database. The adapter information database includes an adapter registration ID, which is the index information of this database, user ID of the owner of the adapter, information regarding the type of the adapter, and adapter ID.

FIG. 7 is a view of an example of the storage media information database. The storage media information database includes media registration ID, which is index information of this database, user ID which has received distribution of digital data, information regarding type of media, and media ID.

The digital data administration database 305 includes a service type database which stores digital data vending service plans that are sold at the site, and a digital data information database that stores information regarding the digital data itself and information regarding the storage locations of the digital data.

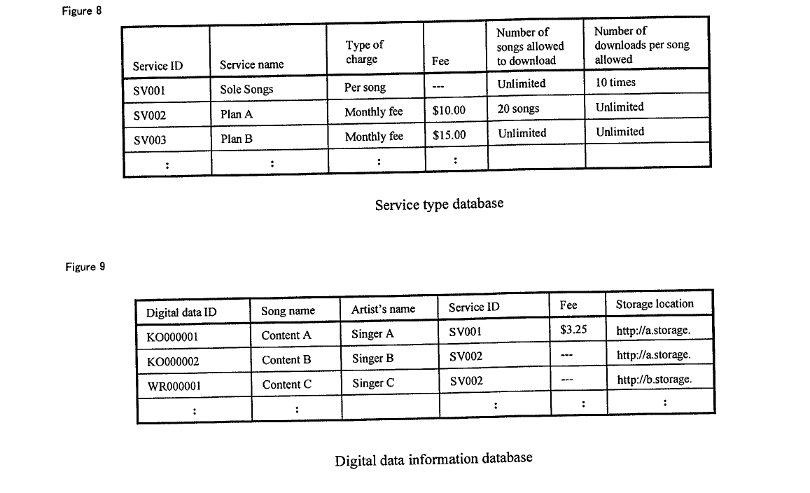

FIG. 8 is a view of an example of the service type database. The service type database includes service ID that is the index information, service name, charge type, which is the payment method type for the service, fee for the service, DL (download) song number limit, which is the limit on the number of songs a user can download, and DL times limit, which is the limit on the number of times of download per song.

FIG. 9 is a view of an example of the digital data information database. The digital data information database includes digital data ID, name of digital data song, name of artist, service ID to which the digital data belongs, fee for the digital data, and storage location information of the digital data.

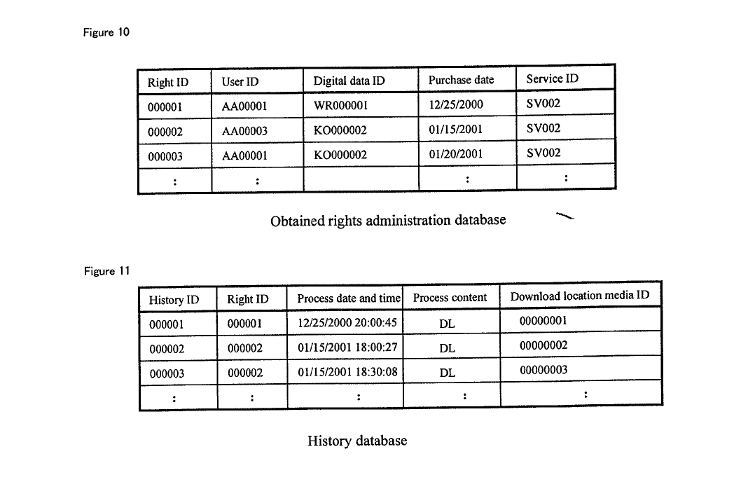

The obtained rights administration database 306 is a database that administers rights to have digital data distributed, which rights the users have obtained. FIG. 10 is a view of its example. The obtained rights administration database 306 includes right ID, which is the index, user ID which has obtained a right to have digital data distributed, digital data ID of the digital data, date of purchasing the right, and service ID to which the digital data belongs.

The history database 307 is a history database that administers information regarding distributions made to users. FIG. 11 is a view of its example. The history database 307 includes history ID, which is the index, pertinent right ID, date of the process, type of the process, and DL location media ID.

The distribution digital data storage means 308 stores the digital data to be distributed, after encrypting the digital data with a predetermined encryption system. The distributed digital data storage means 308 also stores the decryption keys. Hereinafter, the encryption system employed herein is referred to as a first encryption system.

The distribution front end 309 creates homepage screen data of homepages to which the user accesses, and provides the homepage screen data to the user. The distribution front end 309 also executes processes of responding to operations that the user performs on the homepage screen data created by the distribution front end 309.

The digital data distribution means 310 executes a process of sending the encrypted digital data and the decryption key that are stored in the distribution digital data storage means 308 to the storage means access adapter 303.

The sending and receiving means 311 and the communication means 315 execute a communication process between the distribution server 301 and the receiving device 302. This communication process is executed securely using certain technologies such as SSL (Secure Socket Layer) as needed.

The secure communication means 312 and the secure communication means 318 communicate with each other, thereby establishing a secure communication path between the distribution server 301 and the storage media access adapter 303. Communication between each structural element within the distribution server 301 and each structural element within the storage media access adapter 303 is conducted through this secure communication path.

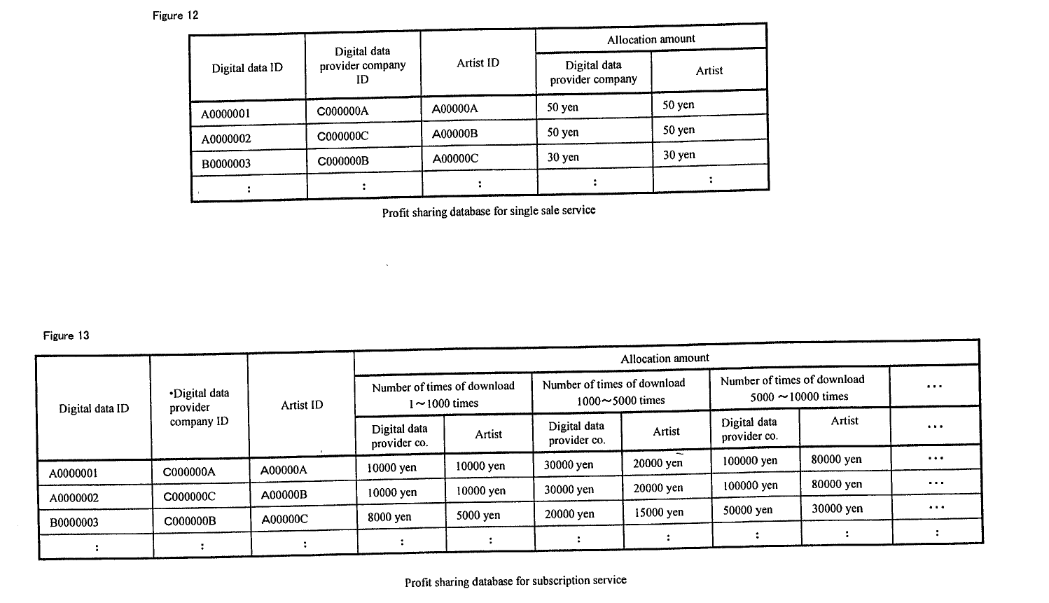

The profit sharing database 313 is a database that administers information for allocating to digital data provider companies and artists the profits earned by the digital data distribution service company. Contents of the profit sharing database 313 are determined through discussion by the digital data distribution service company, digital data provider companies and artists, prior to starting the services. The profit sharing database 313 includes a profit sharing database for a single sale service that administers profit sharing information for single sale services, and a profit sharing database for a subscription service that administers profit sharing information for subscription services. FIG. 12 is a view of an example of the single sale service profit sharing database. The single sale service profit sharing database includes digital data ID, ID of the digital data provider company that provides digital data designated by the digital data ID, ID of the artist who is a holder of rights to the digital data, and the amount of money to be allocated to the digital data provider company and the artist each time the digital data is purchased. FIG. 13 is a view of an example of the subscription service profit sharing database. The subscription service profit sharing database includes digital data ID, ID of the digital data provider company that provides the digital data designated by the digital data ID, ID of the artist who is the holder of rights to the digital data, and the amount of money to be allocated to the digital data provider company and the artist when the digital data is downloaded, the amounts being specified for different numbers of times of download.

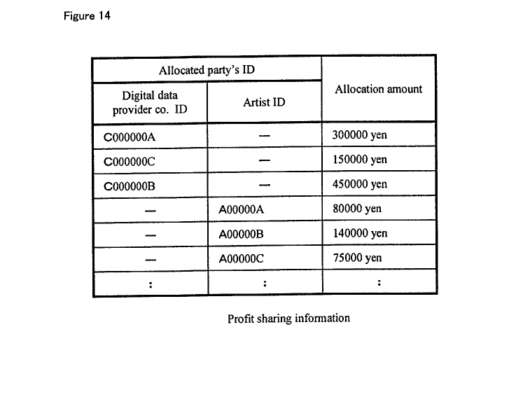

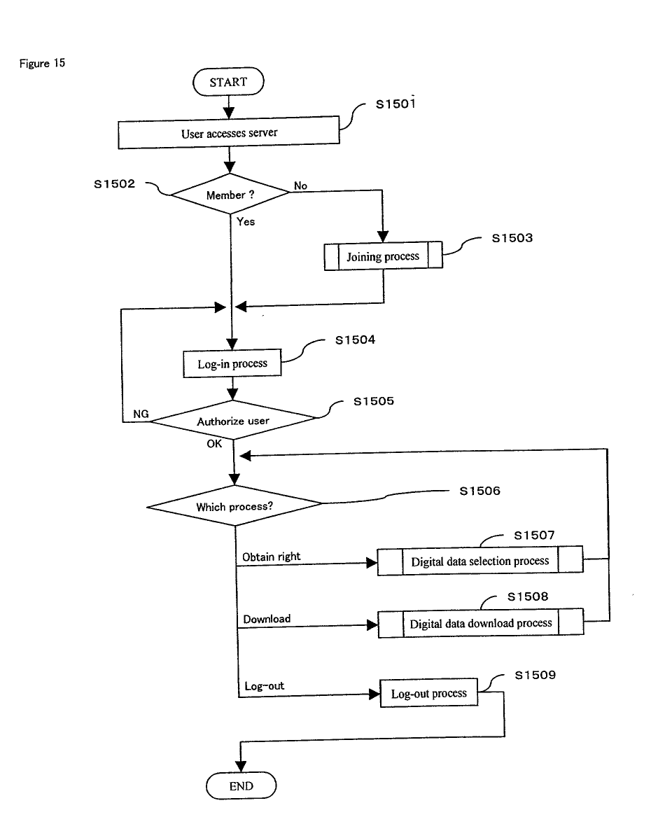

The profit sharing means 314 creates profit sharing data as shown in FIG. 14, by referring to the history database 307, the obtained rights administration database, and the profit sharing database 313. The profit sharing information includes digital data provider company ID to which profit is allocated, artist ID, and the amount of money to be allocated to each. The profit sharing means 314 executes the closing process based on the profit sharing information, and allocates the profits.

The browsing means 316 displays the homepage screen data. The browsing means 316 also receives and processes operations that the user performed on the homepage screen data.

The adapter connection control means 317 connects the receiving device 302 and the storage media access adapter 303, such that the distribution server 301 and the storage media access adapter 303 can communicate with each other via the receiving device 302.

The adapter ID detecting means 319 detects the adapter ID 325 that is included in the storage media access adapter 303, and sends the adapter ID 325 to the distribution server 301.

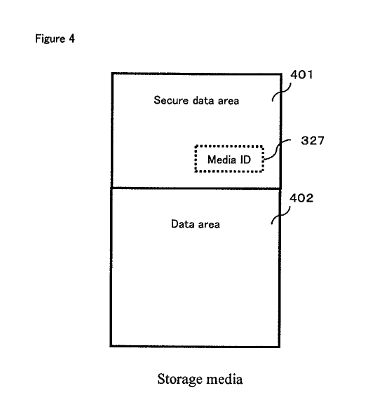

The media ID detecting means 320 obtains from the storage media 326 the media ID 327, which will be described later, and sends the media ID 327 to the distribution server 301. As shown in FIG. 4, the storage media 326 has a secure data area 401, which requires an authorization at the time of access, and a data area 402, which can be accessed without an authorization. The media ID 327, which is an ID that can uniquely identify the storage media, is stored in the secure data area 401.

The encryption conversion means 321 decrypts digital data when it receives from the digital data distribution means 310 the digital data that has been encrypted with the first encryption system and its decryption key. Then, the encryption conversion means 321 encrypts the decrypted digital data using a predetermined encryption system. Hereinafter in this embodiment, the encryption system that is used herein is referred to as a second encryption system.

The decryption key encryption means 322 encrypts the key that the encryption conversion means 321 has utilized to encrypt the digital data with the second encryption system, by using the media ID 327 that has been detected by the media ID detecting means 320.

The media access control means 323 controls the storage media access means 324, which is a means to access the storage media 326. In this manner, writing and reading of data in and from the storage media 326 are controlled. The media access control means 323 controls the storage media access means 324, stores in the data region 402 the digital data that the encryption conversion means 321 has encrypted with the second encryption means, and stores in the secure data area 401 the key that the decryption key encryption means 322 has encrypted.

Operation of each element will now be explained below, with respect to each operation offered by the digital data distribution system.

First of all, a flow of the overall operation of the digital data distribution system will be explained, referring to the flowchart in FIG. 15.

(S1501) The user accesses the distribution server 301, using the browsing means 316.

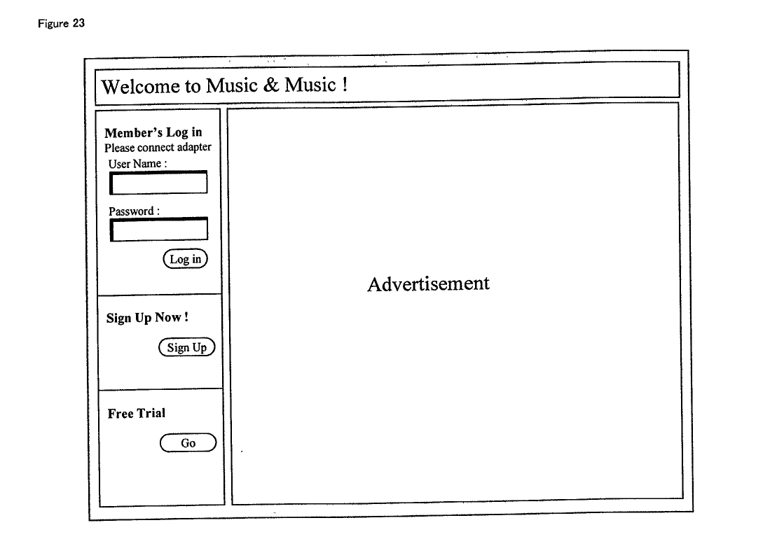

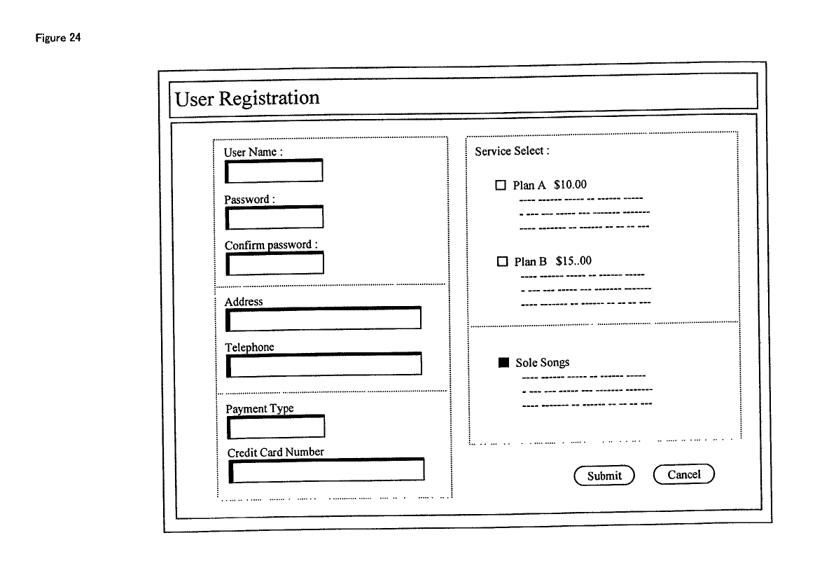

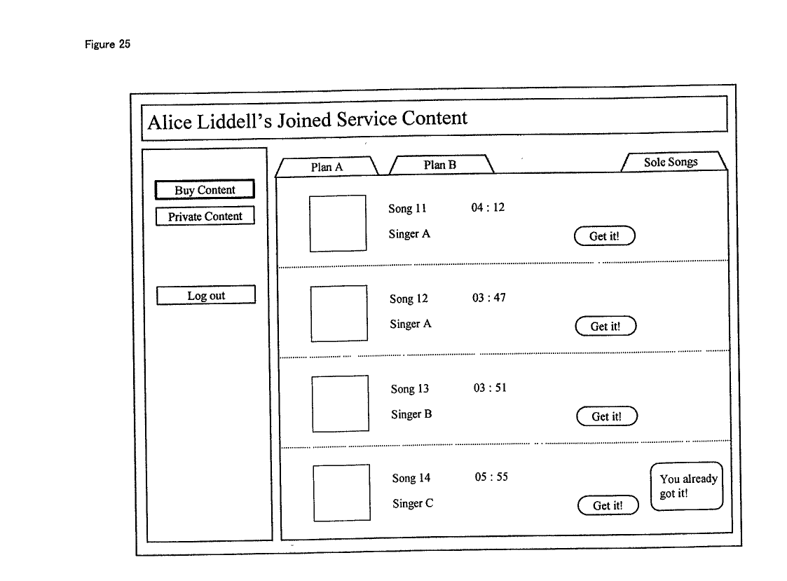

(S1502) The distribution front end 309 creates data for a log-in screen such as one shown in FIG. 23, and sends the log-in screen data to the receiving device 320. The browsing means 316 displays the log-in screen.

(S1503) If the user is not a member of this service, a joining process, which will be described later, is executed.

(S1504) The user confirms that the storage media access adapter 303 is connected to the receiving device 302. If the storage media access adapter 303 is not connected, the user connects it. Then, the adapter connection control means 317 controls the connection status between the receiving device 302 and the storage media access adapter 303, such that the distribution server 301 and the storage media access adapter 303 can communicate with each other via the receiving device 302. Thereafter, the user inputs the user name and the password, and executes the Log-in button on the log-in screen displayed in S1502. Once the Log-in button is executed, the browsing means 316 sends the inputted user name and password to the distribution server 301. The adapter ID detecting means 319 detects the adapter ID 325, and sends the adapter ID 325 to the distribution server 301. This communication utilizes a secure communication path that is established by the secure communication means 312 and the secure communication means 318 through mutual communication. Hereinafter, communication between each structural element within the distribution server 301 and each structural element within the storage media access adapter 303 basically utilizes this secure communication path.

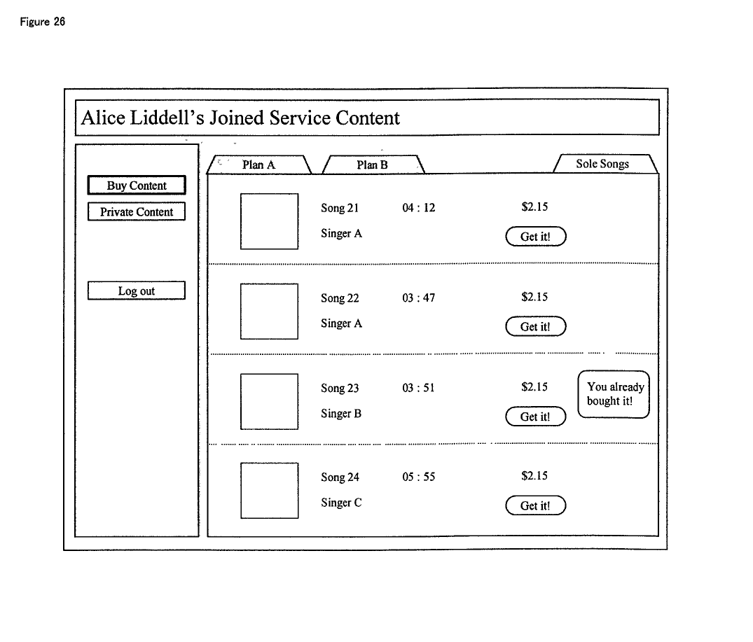

(Sl5O5) The distribution front end 309 refers to the user administration database 304, and determines the user based on the user name, password, and the adapter ID 325 that have been sent in S1504. Then, the distribution front end 309 creates data for a selection screen such as one shown in FIG. 25, which is customized for the user identified above and allows the user to select a song to obtain right to download. Then, the distribution front end 309 sends the screen data to the receiving device 302. If the information that has been sent in S1504 is illegitimate, the distribution front end 309 creates data for a screen which notifies the user of the illegitimacy and urges the user to log-in again. Then, the screen data is sent to the receiving device 302.

(S1506) In the screen such as one shown in FIG. 25, the user utilizes the browsing means 316, and selects a process he wishes to execute from: obtainment of right to download digital data, downloading of digital data with respect to which the right to download has already been obtained, and log-out.

(S1507) If the user has selected obtainment of right to download digital data in S1506, a digital data selection process, which will be described later, is executed. Then, the system returns to S1506.

(S1508) If the user has selected in S1506 the downloading of digital data with respect to which the right to download has already been obtained, a digital data downloading process, which will be described later, is executed. Then, the system returns to S1506.

(S1509) If the user has selected log-out in S1506, the connection between the distribution server 301 and the receiving device 302 is disconnected, and this process ends.

The above concludes the explanation of the flow of the overall operation of the digital data distribution system.

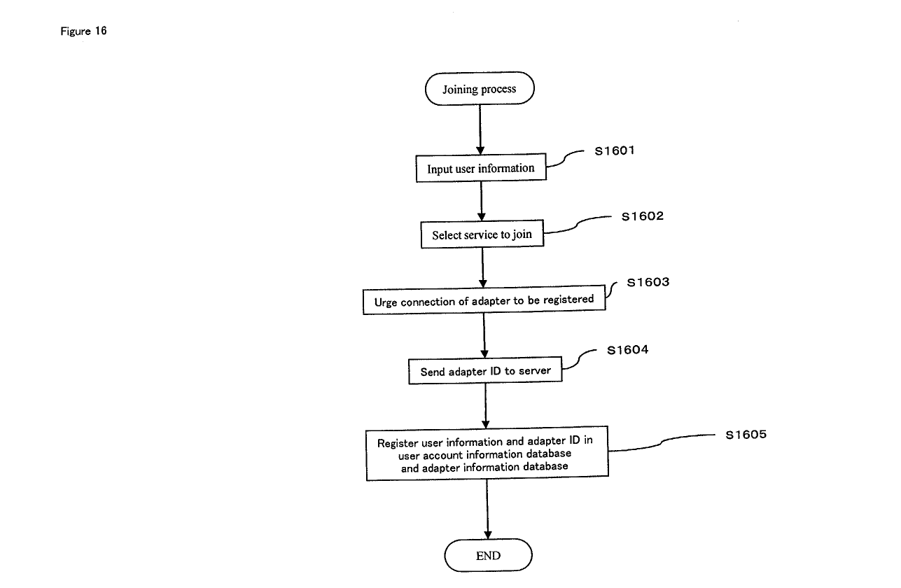

FIG. 16 shows an operational flow of the joining process. The joining process is a process for conducting procedures to let a user become a member to receive a service. Its operation will be described below.

(S1601) The distribution front end 309 creates data for a user registration screen such as one shown in FIG. 24, and sends the data to the receiving device 302. The browsing means 316 displays the user registration screen. The user then fills in required items, namely the user name, the password, the address, the phone number, and the credit card number to be used for payment.

(S1602) Next, the user selects the service he wishes to join. In the case of the single subscription service, the user does not need to go through the joining process at this point, since the user makes payment each time he purchases a song. The browsing means 316 sends the inputted information to the distribution server 301.

(S1603) Next, the distribution front end 309 creates a screen which urges the user to connect the receiving device 302 with the storage media access adapter 303 that will be utilized as a device for writing digital data in this service. Then, the distribution front end 309 sends the screen to the receiving device 302. The user connects the receiving device 302 with the storage media access adapter 303 that he wishes to use as a device for writing digital data.

(S1604) The adapter ID detecting means 319 detects the adapter ID 325, and sends the adapter ID 325 to the distribution server 301.

(S1605) The information sent in S1602 and S1604 is stored in the user account information database 304 by the distribution front end 309.

The above concludes the explanation of the joining process.

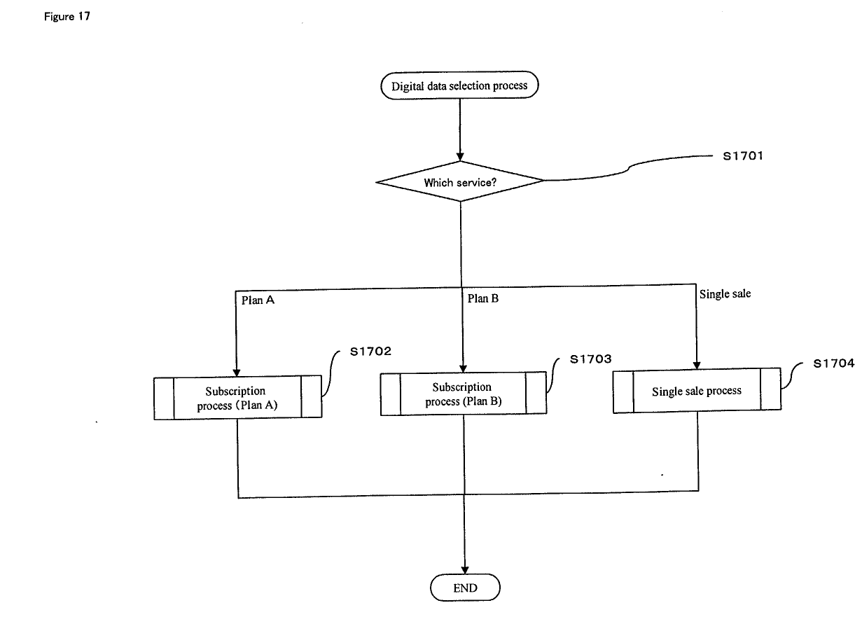

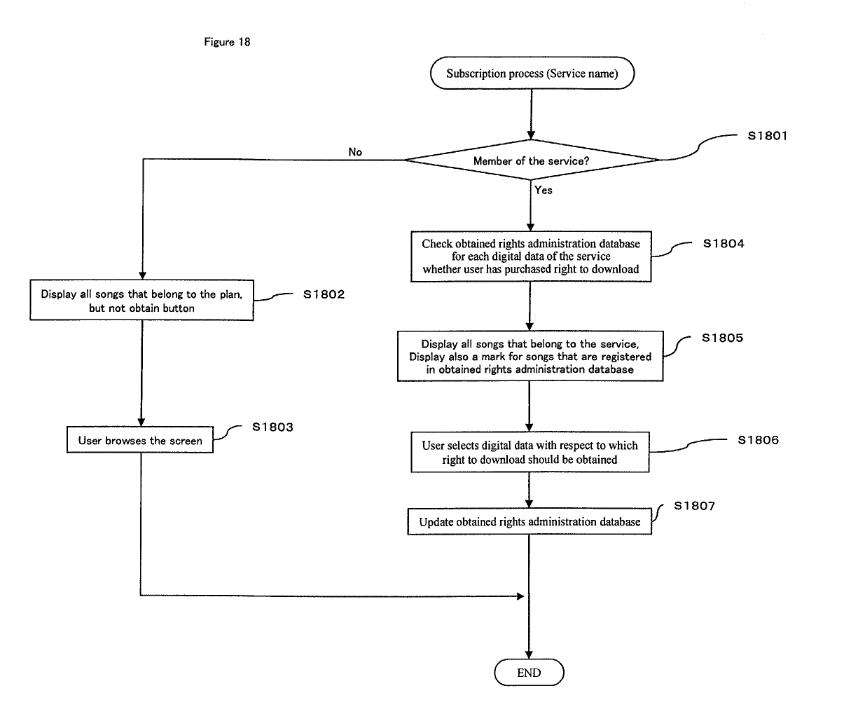

FIG. 17 shows an operational flow of the digital data selection process. The digital data selection process is a process by which a user obtains a right to download digital data. Its operation will be described below.

(S1701) The user selects the service he wishes to receive, using the browsing means 316.

(S1702-S1704) If the service that the user selected in S1701 is a subscription service, a subscription handling process, which will be described later, is executed. If the service that the user selected in S1701 is a single sale service, a single sale handling process, which will be described later, is executed.

This concludes the description of the digital data selection process.

FIG. 18 shows an operational flow of the subscription handling process. The subscription handling process is a process in which a user obtains a right to download digital data that is distributed in the selected subscription service. Its operation will be described below.

(S1801) First of all, the distribution front end 309 refers to the user administration database 304, and verifies whether the user is a member of the subscription service that has been selected.

(S1802) If it is determined in S1801 that the user is not a member, the distribution front end 309 creates a screen that shows a list of digital data that belong to the selected service according to the digital data administration database 305, such that a selection of digital data cannot be made. The screen is sent to the receiving device 302. The browsing means 316 displays the screen.

(S1803) In this case, the user can only browse the digital data list, using the browsing means 316.

(S1804) If it is determined in S1801 that the user is a member, the distribution front end 309 refers to the obtained rights administration database 306, and determines for each digital data that is included in the selected subscription service whether the user has already obtained the right to download.

(S1805) The distribution front end 309 displays a list of digital data that belong to the selected service according to the digital data administration database 305, such that the user can make a selection. For the digital data with respect to which the right to download has already been obtained as determined in S1804, the distribution front end 309 creates screen data in which these digital data bear a mark indicating that the right has already been obtained. The screen data is sent to the receiving device 302. The browsing means 316 displays the screen. An example of the screen is shown in FIG. 25.

(S1806) The user selects digital data that he wishes to obtain, using the browsing means 316. Then, the browsing means 316 sends the information to the distribution server 301.

(S1807) The distribution front end 309 newly registers in the obtained rights administration database 306 information regarding the digital data with respect to which the right to download has been requested, based on the information that has been sent out in S1806.

The above concludes the explanation of the subscription handling process.

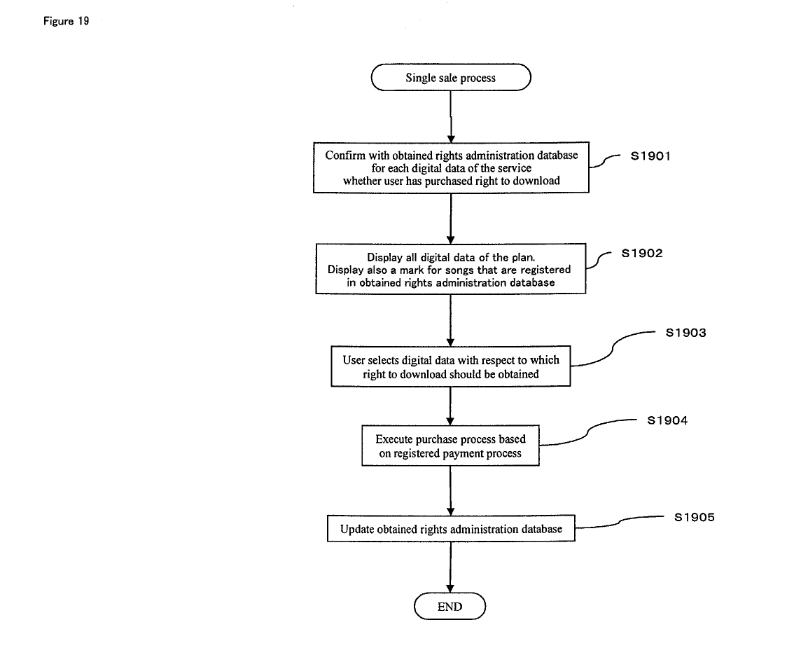

FIG. 19 shows an operational flow of the single sale handling process. The single sale handling process is a process in which a user obtains the right to download digital data that is distributed in the single sale service. Its operation will be explained below.

(S1901) The distribution front end 309 refers to the obtained rights administration database 306, and determines for each of digital data that are included in the single sale service whether the user has obtained right to download.

(S1902) The distribution front end 309 displays a list of digital data that belong to the single sale service according to the digital data administration database 305, such that the user can make a selection. Furthermore, for the digital data with respect to which the user has obtained the right to download as determined in S1901, the distribution front end 309 creates screen data in which these digital data bear a mark indicating that the right has already been obtained. The screen data is sent to the receiving device 302. The browsing means 316 displays the screen. An example of the screen is shown in FIG. 26.

(S1903) The user selects the digital data that he wishes to obtain, using the browsing means 316. The browsing means 316 sends the information regarding the selected digital data to the distribution server 301.

(S1904) The distribution front end 309 calculates the price of digital data with respect to which the user has requested a right to download, referring to the digital data administration database 305. Then, a purchasing process is executed using the payment information such as credit card information registered in the user administration database 304.

(S1905) The distribution front end 309 newly registers in the obtained rights administration database 306 the information regarding the digital data for which the purchasing process has been executed.

The above concludes the explanation of the single sale handling process.

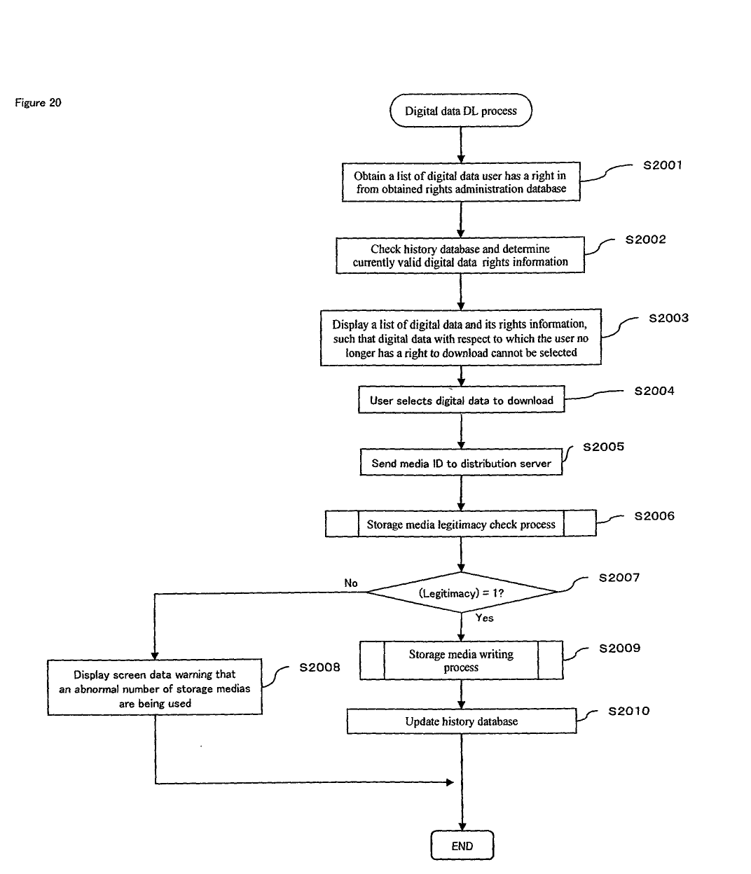

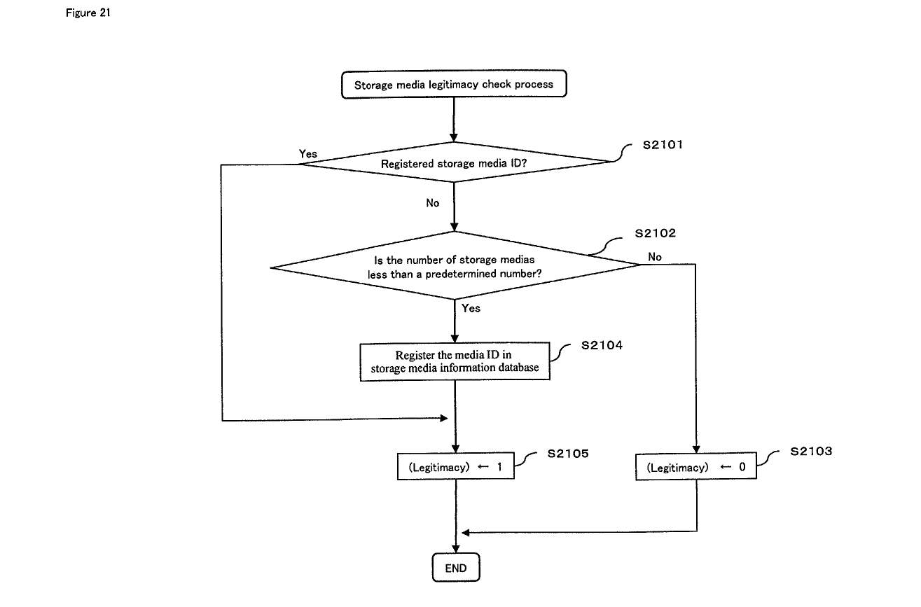

FIG. 20 shows an operational flow of the digital data download process. The digital data download process is a process in which the user downloads digital data. Its operation will be described below.

(S2001) First of all, the distribution front end 309 obtains from the obtained rights administration database 306 a list of digital data with respect to which the user has obtained the right to download.

(S2002) Next, the distribution front end 309 determines, for each of the digital data shown in the list that has been obtained in S2001, whether the digital data is available for downloading by referring to the history database 307 and the digital data administration database 305. If it is, the distribution front end 309 further determines how many times more the digital data can be downloaded.

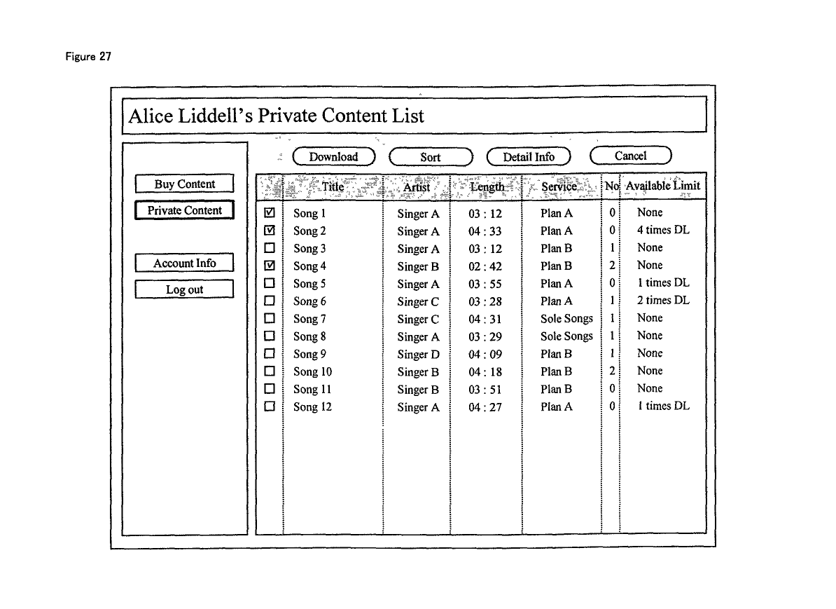

(S2003) Then, the distribution front end 309 creates, based on the result in S2002, a screen data such as one shown in FIG. 27. The screen data shows a list of digital data with respect to which the user has the right to download, and the number of times the digital data can be downloaded. The screen data is sent to the receiving device 302. The browsing means 316 displays the screen.

(S2004) The user selects digital data he wishes to download, using the browsing means 316. The browsing means 316 sends the information to the distribution server 301.

(S2005) Next, the media ID detecting means 320 detects the media ID 327 of the storage media 326 that is connected to the storage media access adapter 303. Then, the media ID detecting means 320 sends the media ID 327 to the distribution server 301.

(S2006) The distribution front end 309 executes a storage media legitimacy check process, which will be described later, on the storage media 326 having the media ID 327 that has been sent by the media ID detecting means 320 in S2005.

(S2007) The distribution front end 309 verifies the legitimacy of the storage media 326 having the media ID 327 that has been sent by the media ID detecting means 320 in S2005.

(S2008) If it is determined that the storage media 326 is not legitimate in S2007, the distribution front end 309 creates screen data that warns that the storage media may be illegitimate. The screen data is sent to the receiving device 302. The browsing means 316 displays the screen.

(S2009) If it is determined that the storage media 326 is legitimate in S2007, a storage media writing process, which will be described later, is executed.

(S2010) Lastly, the distribution front end 309 adds to the history database 307 the information that the digital data has been downloaded.

The above concludes the explanation of the digital data download process.

FIG. 21 shows an operational flow of the storage media legitimacy check process. The storage media legitimacy check process is a process by which distribution server 301 checks the legitimacy of the storage media 326 in which the user is about to write the digital data. Its operation will now be explained.

(S2101) The distribution front end 309 verifies whether the media ID 327 that has been sent in S2005 is registered in the storage media information database of the user administration database 304. If the distribution front end 309 determines that the media ID 327 is registered, the system proceeds to the process of S2105.

(S2102) If it is determined in S2101 that the media ID 327 is not registered, the distribution front end 309 determines from the storage media information database of the user administration database 304 the number of storage medias 326 that the same user has already used. Then, the distribution front end 309 determines whether the number of the storage medias 326 is greater than a predetermined number.

(S2103) If it is determined in S2102 that the number of the storage medias 326 is greater than the predetermined number, the distribution front end 309 determines that the storage media 326 being checked is not legitimate.

(S2104) If it is determined in S2102 that the number of the storage medias 326 is not greater than the predetermined number, the distribution front end 309 adds the media ID 327 that has been sent in S2005 in the storage media information database of the user administration database 304. The system proceeds to the process of S2105.

(S2105) The distribution front end 309 determines that the storage media 326 being checked is legitimate.

This concludes the description of the storage media legitimacy check process.

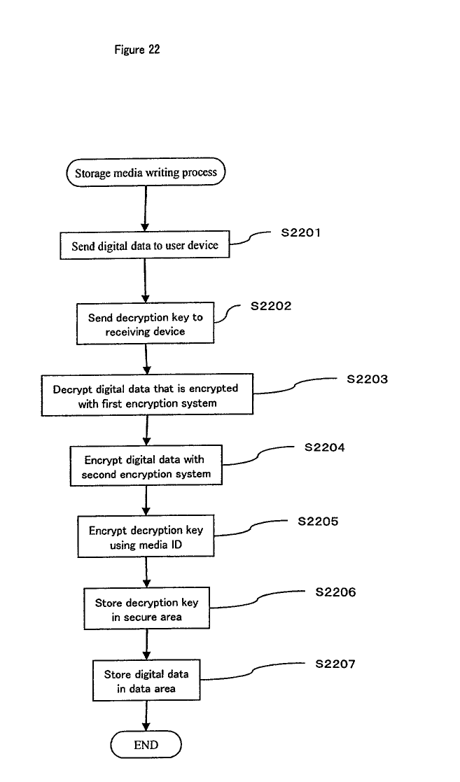

FIG. 22 shows an operational flow of the storage media writing process. The storage media writing process is a process in which digital data and its decryption key are written in the storage media 326. Its operation will now be explained.

(S2201) The digital data distribution means 310 sends to the storage media access adapter 303 the digital data which is stored in the distribution digital data storage means 308, and with respect to which a request for downloading has been made.

(S2202) The digital data distribution means 310 sends to the storage media access adapter 303 the decryption key for the digital data which is stored in the distribution digital data storage means 308, and with respect to which a request for downloading has been made.

(S2203) The encryption conversion means 321 decrypts the digital data that the digital data distribution means 310 has sent in S2201, using the decryption key that the digital data distribution means 310 has sent in S2202.

(S2204) The encryption conversion means 321 encrypts the digital data that the encryption conversion means 321 has decrypted in S2203, using the second encryption system.

(S2205) The decryption key encryption means 322 encrypts the key that was utilized when the encryption conversion means 321 encrypted the digital data in S2204, using the media ID 327 that the media ID detecting means 320 has detected.

(S2206) The media access process control means 323 stores the key that the decryption key encryption means 322 has encrypted in S2205 in the secure data area 401 of the storage media 326, by controlling the storage media access means 324.

(S2207) The media access process control means 323 stores the digital data that the encryption conversion means 321 has encrypted in S2204 in the data area 402 of the storage media 326, by controlling the storage media access means 324.

This concludes the explanation of the storage media writing process.

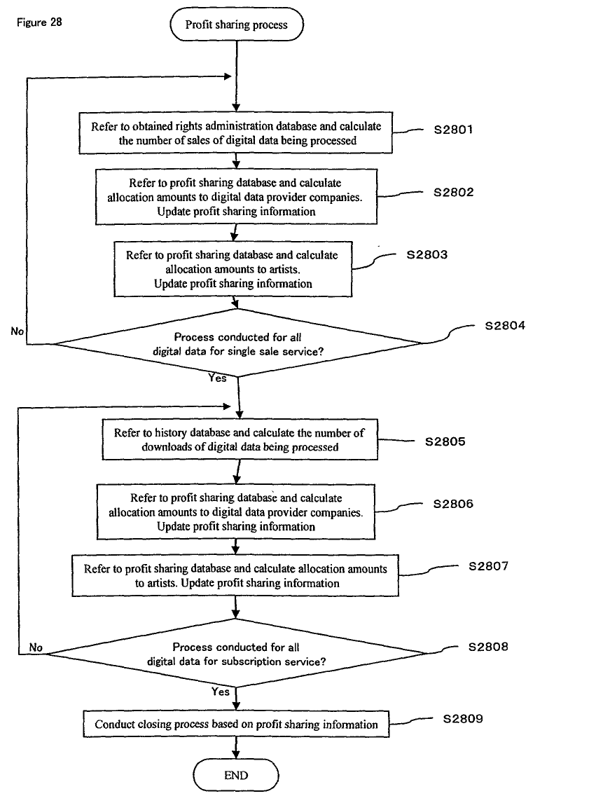

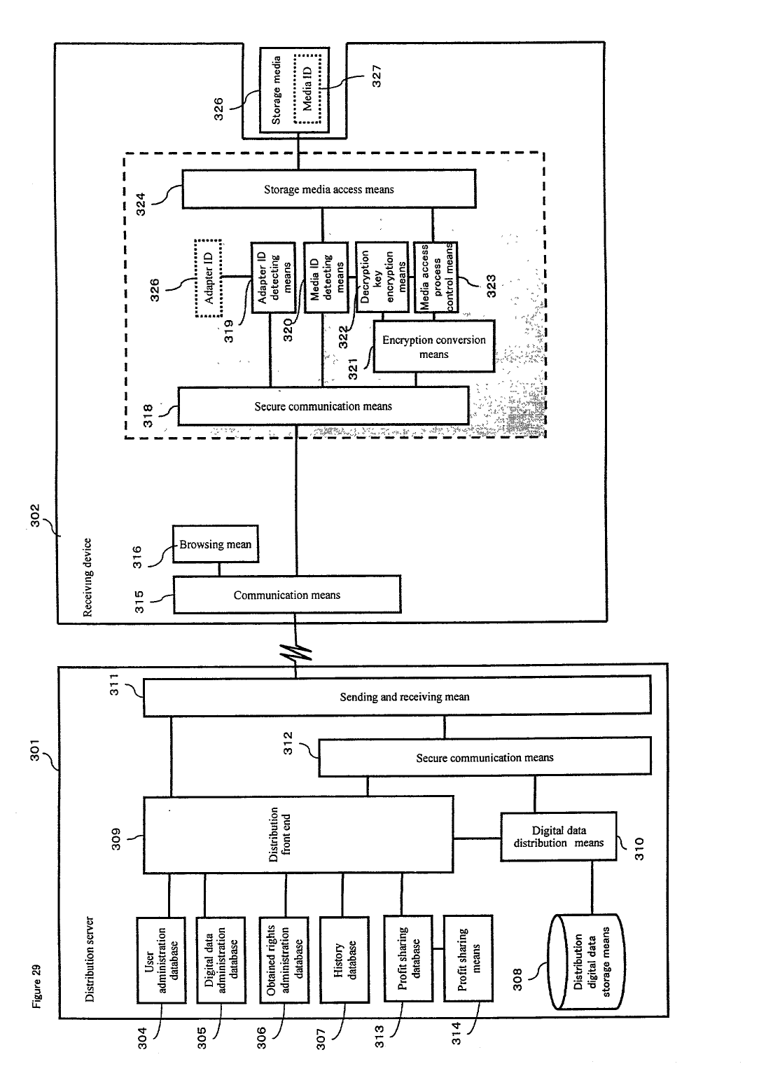

FIG. 28 shows an operational flow of the profit sharing process. The profit sharing process is a process in which the profits earned by the digital data distribution company are allocated to the digital data provider companies and the artists who are the holders of rights to digital data. Its operation will now be explained. The profit sharing process is conducted every predetermined period of time, for instance, every month.

(S2801) The profit sharing means 314 refers to the obtained rights database 306 to calculate the number of sales of digital data for which the process is being conducted, in the period for which the process is being conducted.

(S2802) The profit sharing means 314 refers to the profit sharing database 313, and calculates the amount of money to be allocated to the digital data provider company, based on the number of sales calculated in S2801. Then, the profit sharing means 314 updates the profit sharing information shown in FIG. 14.

(S2803) The profit sharing means 314 refers to the profit sharing database 313, and calculates the amount of money to be allocated to the artist, based on the number of sales calculated in S2801. Then, the profit sharing means 314 updates the profit sharing information shown in FIG. 14.

(S2804) Once the processes S2801-2803 are conducted on every digital data that belongs to the single sale service, the system proceeds to the process of S2805. If there is digital data belonging to the single sale service for which the processes of S2801-S2803 have not been conducted, the system returns to S2801.

(S2805) The profit sharing means 314 refers to the history database 307 and calculates the number of downloads of digital data for which the process is being conducted, within the period for which the process is being conducted.

(S2806) The profit sharing means 314 refers to the profit sharing database 313, and calculates the amount of money to be allocated to the digital data provider company, based on the number of downloads calculated in S2805. Then, the profit sharing means 314 updates the profit sharing information shown in FIG. 14.

(S2807) The profit sharing means 314 refers to the profit sharing database 313, and calculates the amount of money to be allocated to the artist, based on the number of downloads calculated in S2805. Then, the profit sharing means 314 updates the profit sharing information shown in FIG. 14.

(S2808) Once the processes S2805-2807 are conducted on every digital data that belongs to the subscription service, the system proceeds to the process of S2809. If there is digital data belonging to the subscription service for which the processes of S2805-S2807 have not been conducted, the system returns to S2805.

(S2809) The profit sharing means 314 executes a closing process based on the profit sharing information, and allocates the profit to each party to which profits are to be allocated.

The above concludes the description of the profit sharing process.

This concludes the description of the digital data distribution system in accordance with the embodiment of the present invention.

Although digital data is music data in the embodiment, digital data can be other general electronic data, such as motion picture, static picture, digital book, and software.

Furthermore, although the services offered in the embodiment are the subscription service which allows unlimited number of downloads and the subscription service which has a predetermined limit on the number of downloads, other services that have different criteria can be offered, if those services can be offered based on information stored in the history database.

Furthermore, in the embodiment, the screens displayed by the browsing means 316 are shown in figures. However, these screens are only examples. Actual screens may vary depending on presentation and design of the services.

Furthermore, in the embodiment, the storage media 326 has the secure data area 401 and the non-secure data area 402. However, a storage media that does not have a secure data area 401 can also be used if the storage media has a media ID 327 that cannot be tampered with.

Furthermore, although the receiving device 302 is a STB in the first through third embodiments, the receiving device may also be a portable phone or a personal computer.

Furthermore, one of the information that authorizes the user is the user name and password in the embodiment. However, it is not always necessary to use the user name and password. Other information, such as the adapter ID 325 only or a combination of the adapter ID 325 and other information may be utilized for authorization of the user.

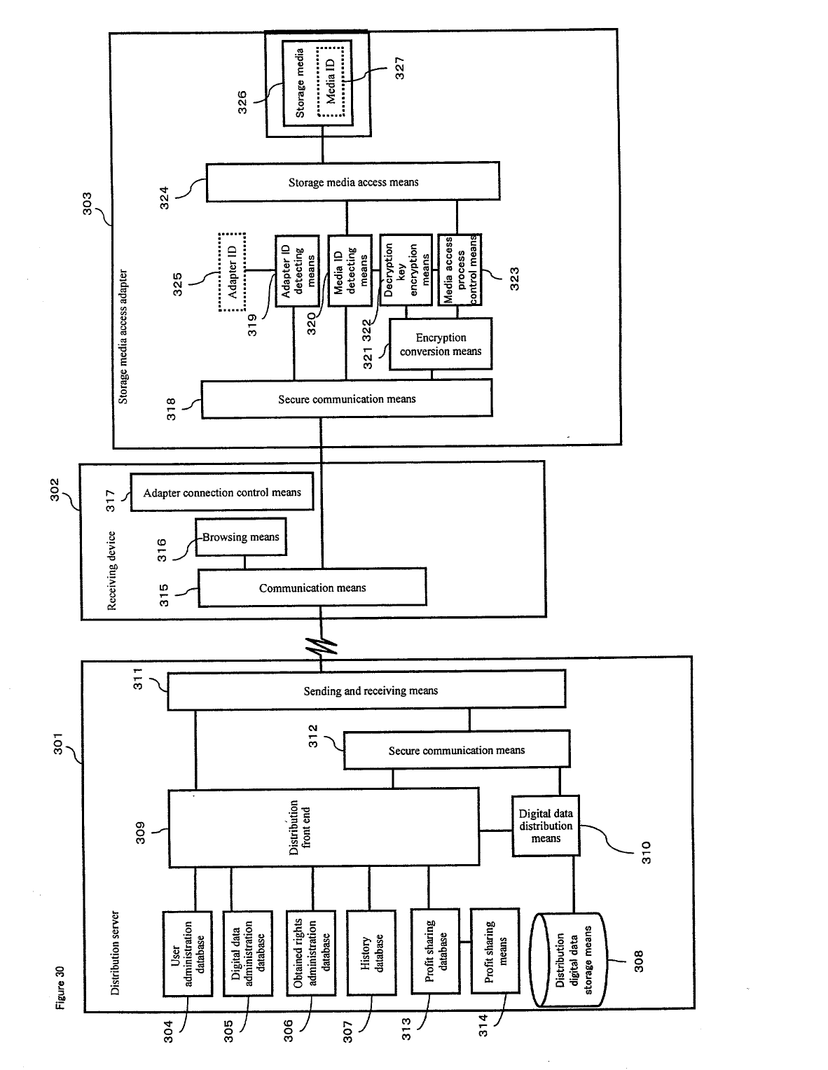

Furthermore, each structural element of the storage media access adapter 303 may be equipped inside the receiving device 302, as seen in FIG. 29.

Furthermore, although each structural element within the storage media access adapter 303 is installed in one LSI in the embodiment, these elements do not necessarily need to be installed in one LSI, as shown in FIG. 30.

Furthermore, although the communication between the distribution server 301 and the receiving device 302 is conducted via the Cable in the embodiment, other communication lines such as the Internet, the telephone line, and satellite communication may also be utilized. Additionally, different communication paths may be used for upstream and downstream lines, the downstream line being from the distribution server 301 to the receiving device 302, and the upstream line being from the receiving device 302 to the distribution server 301.

Furthermore, although the parties to which profits are allocated are only the digital data provider companies and the artists in the embodiment, the profits may also be allocated to other parties, such as songwriters and lyrics writers.

With the digital data distribution system described above, even in the case of subscription type services, profits can properly be allocated to holders of rights to distributed digital data.

What is claimed is:

1. A distribution server for distributing digital data, comprising:
a history database storing information regarding digital data that have been distributed to users in the past;
a profit sharing database storing information regarding amounts to be allocated in order to allocate fees collected from the users to right holders of the digital data that are distributed by said distribution server; and
profit sharing means for calculating the amounts to be allocated to the right holders based on the information in said history database and said profit sharing database, and conducting a closing process.

2. A digital data distribution system, comprising:
a distribution server that distributes digital data;
a receiving device that receives the digital data sent from said distribution server;
a storage media in which the digital data that said receiving device has received is written; and
an adapter that writes in said storage media the digital data that said receiving device has received, wherein
said receiving device includes
communication means for accessing said distribution server,
browsing means for browsing and responding to information sent from said distribution server, and
adapter connection control means for controlling connection with said adapter,
said storage media includes
a media ID, which is information specific to said storage media and cannot be tampered with, said media ID being able to uniquely identify said storage media,
said adapter includes
secure communication means,
an adapter ID that uniquely identifies said adapter,
adapter ID detecting means for extracting said adapter ID and sending said adapter ID to said distribution server,
media ID detecting means for extracting said media ID from said storage media and sending said media ID to said distribution server,
encryption conversion means,
key encryption means,
storage media access means for writing and reading data in and from said storage media, and
media access process control means for controlling the writing and reading in and from said storage media by said storage media access means,
said distribution server includes
secure communication means,
sending and receiving means for sending and receiving information and the digital data to and from said receiving device,
a distribution front end for creating information to be sent to the user and processing accesses by the user,
a user administration database that stores user IDs and account information of related users,
a digital data administration database that stores storage location information and use conditions of digital data to be distributed,
an obtained rights administration database that stores information regarding a right to receive distribution of digital data that each user has obtained,
a history database that stores information regarding digital data that has been distributed to the users in the past,
an adapter administration database that stores adapter IDs of adapters that each user uses,
a storage media administration database that stores media IDs of storage medias that each user uses,
a profit sharing database that stores information regarding amounts to be allocated when fees collected from the users are allocated to right holders of the digital data that are distributed by said distribution server,
profit sharing means for calculating the amounts to be allocated to each of the right holders based on the information in said history database and said profit sharing database, and conducting a closing process based on the calculation,
distribution digital data storage means for storing digital data that are encrypted with a first encryption system and decryption keys for decrypting the digital data that are encrypted with the first encryption system, and
digital data distribution means for sending to said receiving device the digital data encrypted with the first encryption system and the decryption key based on a direction from said distribution front end, the digital data and the decryption key being stored in said distribution digital data storage means,
said encryption conversion means decrypts the digital data that is encrypted with the first encryption system and distributed by said digital data distribution means, using the decryption key distributed by said digital data distribution means, and encrypts the decrypted digital data with a second encryption system,
said key encryption means encrypts the key that has been utilized when said encryption conversion means encrypted the digital data with the second encryption system, using said media ID detected by said media ID detecting means,
said storage media access control means controls said storage media access means and writes the key encrypted by said key encryption means in said storage media,
said secure communication means of said adapter and said secure communication means of said distribution server communicate with each other, thereby establishing a secure communication path between said adapter and said distribution server,
the communication between each structural element within said adapter and each structural element within said distribution server is conducted through said secure communication path that has been established,
said distribution front end authorizes a user based on said adapter ID sent from said adapter ID detecting means, and
said distribution front end determines whether the digital data with respect to which distribution is requested can be distributed, by referring to said obtained rights administration database, said history database, said digital data administration database, and said storage media administration database, in order to execute processes in response to a request for distribution of digital data from the authorized user.

3. A profit sharing method for sharing profits earned from a digital data distribution system, wherein
in said digital data distribution system set forth in claim 2,
said profit sharing means refers to said history database and said profit sharing database, said profit sharing means calculating based on the information the amount to be allocated to each right holder and conducting a closing process based on the calculated amount.
